(19) United States
(12) Patent Application Publication
(10) Pub. No.: US 2010/0176617 A1
(43) Pub. Date: Jul. 15, 2010

(54) MOTOR VEHICLE APRON TRIM ELEMENT

(75) Inventors: Julien Khazaal, Maurepas (FR); Jean-Yves Pourrias, Antony (FR); Marc Simon, Noisy Les Sec (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/600,392

(22) PCT Filed: May 14, 2008
(86) PCT No.: PCT/FR2008/050825

§ 371 Date: Mar. 30, 2010

(30) Foreign Application Priority Data
May 14, 2007 (FR) 0703455

(51) Int. Cl. B60R 13/02

(52) U.S. Cl. 296/1.08

(57) ABSTRACT

An arrangement of a trim element on a carrier for accessing an area located behind the trim element, wherein a rear surface of the trim element includes a first supporting mechanism including a series of lower and upper clips engageable with matching clips on the carrier, and the arrangement further includes a second mechanism supporting the trim element so that the trim element can be removed in at least two successive movements in at least two directions chosen from the transverse, vertical, and longitudinal directions.

The invention relates to the arrangement of a trim element of a motor vehicle bumper apron. It also relates to an apron for holding such a trim element, a bumper equipped with such a trim element and a motor vehicle as such comprising such a trim element. It is particularly suitable for decorating a vehicle at the location provided for positioning the tow ring. Finally, the invention also relates to a method for fitting and removing such a trim element.

Nowadays, motor vehicle bumper aprons, as described in document EP1112870, often have a flap which, in its open position, enables access to the means for attaching a tow ring if it is needed. The advantage of such a prior art solution is its ease of use. However, it spoils the overall appearance of the vehicle, the front part of which is discontinuous and cannot have an elaborate trim because of this mechanical constraint caused by the presence of a flap.

The object of the present invention is thus to provide a trim solution in particular for motor vehicle aprons.

The solution is based on an arrangement of a trim element on a substrate enabling access to a localized area behind the trim element, characterized in that a rear face of the trim element comprises first holding means consisting of a series of lower clips and upper clips intended to engage with corresponding clips on the substrate and in that the arrangement further comprises a second holding means for the trim element such that the trim element is detached by at least two successive movements in at least two directions selected from the transverse, vertical and longitudinal directions.

According to one implementation of the invention, the holding means are designed such that the trim element is detached by a first, vertical movement upward in order to release the clips, followed by a second, transverse movement to release the second holding means and then by a third longitudinal movement toward the front of the vehicle to take off the trim element.

According to another alternative, the holding means are designed such that the trim element is detached by a first, escaping movement of the locking means using a tool inserted through an opening made within the substrate, followed by a second, transverse movement to release the second holding means and then by a third, longitudinal movement toward the front of the vehicle to take off the trim element.

The clips of the first holding means for the trim element may be in the form of an upside-down U and may engage with orifices in the substrate having a wide part and a narrow part in order to hold the trim element in the vertical and longitudinal directions.

The second holding means may be in the form of a resilient tab on the substrate engaging with a lug on the trim element in order to hold the trim element in the transverse direction.

According to an alternative embodiment, the detachable trim element is also connected to the substrate by captive tongues.

The trim element may be fitted to an apron or to a grille fitted to an apron.

This arrangement of a trim element on a substrate may represent a decorative element that at least partially conceals access to a tow ring.

Finally, the invention also relates to a motor vehicle comprising an arrangement of a trim element on a substrate as described hereinabove.

These subjects, features and advantages of the present invention will be detailed in the following description of one particular nonlimiting embodiment in connection with the appended figures, in which:

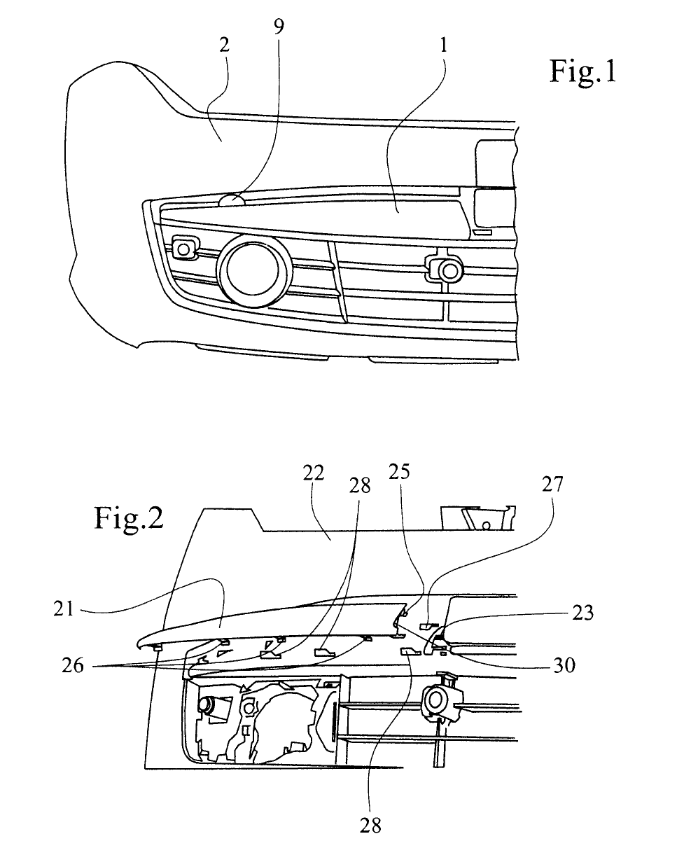

FIG. 1 shows a partial view of a motor vehicle front apron comprising a trim according to one embodiment of the invention;

FIG. 2 shows a front view of a trim element away from its housing on the motor vehicle front apron;

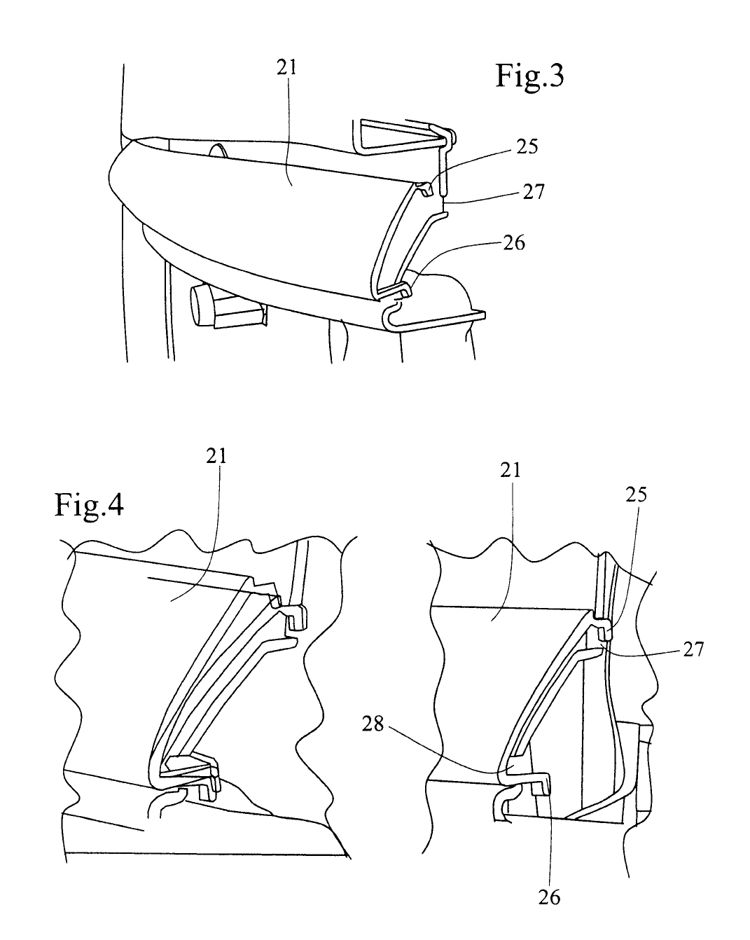

FIGS. 3 to 6 show enlarged views of various steps of the method of fitting the trim element according to the embodiment of the invention;

FIG. 7 shows a rear view of the end part of the connection between the trim element and the apron according to the embodiment of the invention;

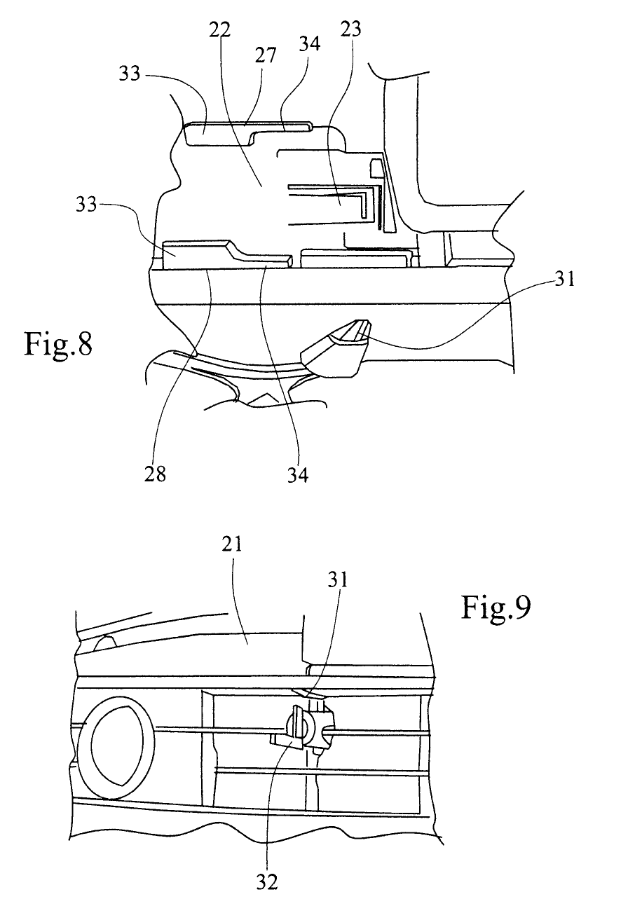

FIG. 8 shows a rear view of just the apron;

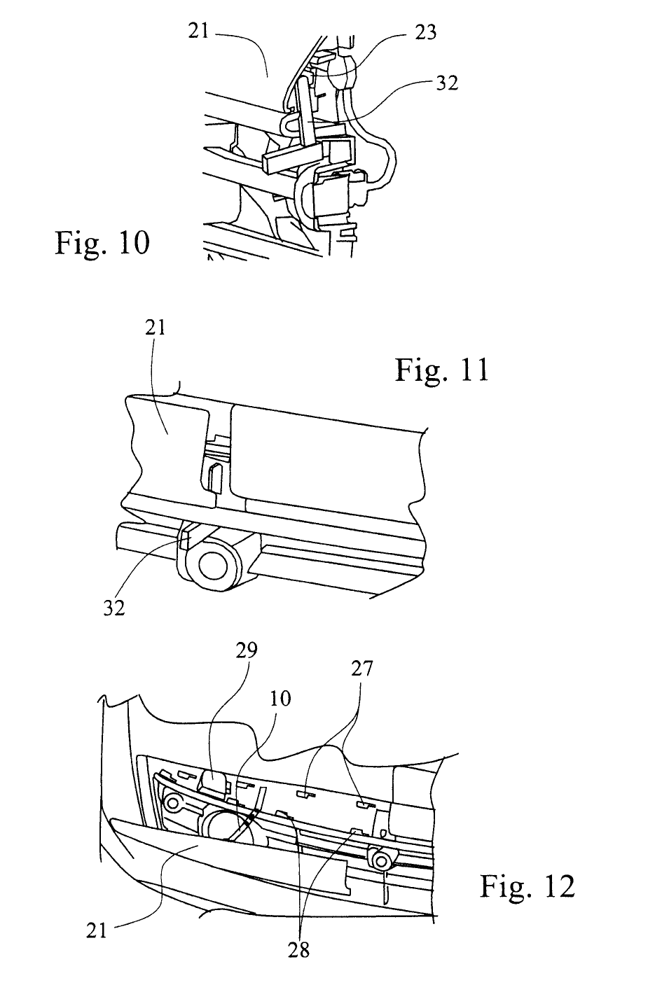

FIGS. 9 to 11 show various steps of the method of fitting the trim element according to the embodiment of the invention; and

FIG. 12 shows a view of the part of the motor vehicle front apron after the trim element has been removed.

According to the embodiment shown in FIG. 1, a detachable trim element 1 may occupy a first position fitted to the apron 2 or to a grille of a motor vehicle bumper apron 2, in which position it at least partially covers the device providing access to the means 9 for attaching a tow ring, and a second or removed position, as shown in FIG. 2 and FIG. 12, which enables access to the towing device.

In order to simplify the following description, the terms “front” and “rear” will be used to denote elements in the longitudinal direction from front to rear of a motor vehicle on which they are normally positioned. The terms “upper” and “lower” will be used to denote elements along a vertical axis perpendicular to the longitudinal axis of the motor vehicle, and “right” and “left” will be used to denote directions along a lateral or transverse axis perpendicular to the longitudinal axis of the motor vehicle when viewing the front of the motor vehicle from the front.

In the embodiment shown, the trim element 1 is an elongate and slightly curved approximately triangular chrome trim strip fitted detachably to the front apron of a motor vehicle by means of a series of clips positioned on its rear face.

Thus, FIGS. 2 to 12 show an embodiment of the invention in which a trim element 21 has attachment means 25, 26 for fastening it to an apron 22.

The trim element 21 according to this embodiment comprises a first holding means consisting of a first series of clips 25 in the upper part of its rear face and a second series of clips 26 in the lower part of its rear face, said clips being provided to engage with first orifices 27 made in the top part of the apron and with second orifices 28 made in its bottom part. As can be seen more particularly in FIG. 7, for example, each connecting orifice 27, 28 of the apron 22 has a form with a wide left-hand part 33 and a narrower right-hand part 34.

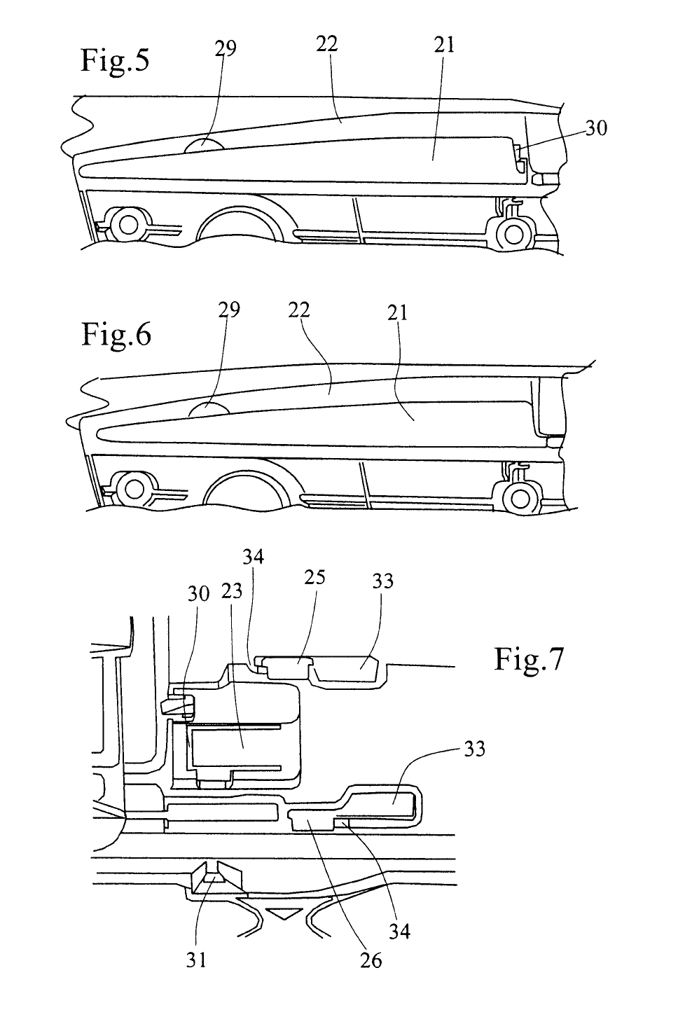

The method of fitting of the apron, illustrated in FIGS. 3 to 6, comprises a first step of inserting the lower clips 26 into the wide left-hand part 33 of the corresponding orifices 28 in the apron, and then pivoting the trim element upward about this lower connection until the upper clips 25 are positioned in the corresponding orifices 27, also at the wide part 33 of said orifices. This first positioning enables the trim element to be connected temporarily in an intermediate position due to its resilient properties. FIG. 5 illustrates the result of this first step of fitting the trim element 21.

A second step of the fitting method consists in a step of locking the apron 21 by moving it to the right in order to position a second holding means which is a locking means positioned toward the right-hand end of the trim element 21. The result of this final step is illustrated in FIG. 6, in which the trim element 21 is partially masking a closing element or flap that enables access to a device 29 for attaching a tow ring.

FIG. 7 illustrates a rear view of the right-hand end of the connection obtained between the trim element 21 and the apron 22. The holding clips 25, 26 are in the form of an upside-down U which overlaps the lower wall of the narrow 34 orifices 27, 28 in the apron so as to hold the apron in the longitudinal and vertical directions. On the other side, the locking means is formed by a transverse resilient tab 23 on the apron 23 able to engage with a lug 30 on the trim element 21, preventing any lateral movement of the trim element 21 to the left, said trim element thus being held in the three directions. FIG. 8 shows a front view of this end part 22 of the apron without the trim element in order that its structure can be clearly seen.

According to an advantageous alternative embodiment, the trim element 21 is also connected to the apron 22 by captive tongues 10 which connect it permanently to the apron 22, even in its removed state, in order to prevent it being lost, as can be seen in FIG. 2.

The method of removal from the apron involves the steps of the fitting method described hereinabove in reverse order. To make it easier to unlock the trim element 21, an opening 31 is provided in the lower part of the apron 22 for the insertion of an L-shaped tool 32 or a simple screwdriver, as illustrated in FIGS. 9 to 11, for acting on the locking tab 23 of the apron 22 in order to free the lug 30 before causing the trim element to move laterally to the left so as to guide the clips 25, 26 into the wide parts 33 of the orifices 27, 28. From this position, these clips can escape from these orifices and the trim element 21 can be removed by moving it in the longitudinal direction as illustrated in FIG. 12.

The solution provides a very simple fitting and removing method using sets of clips having particular forms, enabling the movement to be divided into at least two steps consisting in moving the trim element successively in at least two different directions selected from the longitudinal, lateral or vertical directions in order for the trim element finally to be connected or freed.

The solution provided thus has the following advantages:
it improves the appearance of the motor vehicle apron by dispensing with a flap which was visible in the prior art for access to the towing device;
the mechanism for fitting/removing the trim element is simple and always enables user-friendly implementation of the towing function;
the mechanism for fitting/removing the trim element is designed to prevent any deterioration during fitting or removal operations which involve simple manipulations with few tools; this attractive appearance can be achieved economically and flexibly since different trims can be envisaged on a single apron enabling two or more series of motor vehicles having different appearances to be produced at low cost.

The arrangement of a trim element as described hereinabove has been used very advantageously for the apron of a motor vehicle in combination with the vehicle's towing device, but it could also be employed to provide other areas of the vehicle with trim by means of an identical connection to any other substrate. Further embodiments are conceivable, for example by combining the two embodiments described.

1-8. (canceled)

9. An arrangement of a trim element of a motor vehicle bumper apron enabling access to a localized area behind the trim element,
wherein a rear face of the trim element comprises first holding means including a series of lower clips and upper clips to engage with corresponding clips on the apron; and
wherein the arrangement further comprises a second holding means for the trim element such that the trim element is detached by at least two successive movements in at least two directions selected from transverse, vertical, and longitudinal directions.

10. The arrangement of a trim element as claimed in claim 9, wherein the holding means is configured such that the trim element is detached by a first, vertical movement upward to release the clips, followed by a second, transverse movement to release the second holding means, and then by a third, longitudinal movement toward the front of the vehicle to take off the trim element.

11. The arrangement of a trim element as claimed in claim 9, wherein the holding means is configured such that the trim element is detached by a first, escaping movement of the second holding means using a tool inserted through an opening made within the apron, followed by a second, transverse movement to release the first holding means, and then by a third, longitudinal movement toward the front of the vehicle to take off the trim element.

12. The arrangement of a trim element as claimed in claim 9, wherein the clips of the first holding means for the trim element are in a form of an upside-down U and they engage with orifices in the apron including a wide part and a narrow part to hold the trim element in the vertical and longitudinal directions.

13. The arrangement of a trim element as claimed in claim 9, wherein the second holding means is in a form of a resilient tab on the apron engaging with a lug the trim element to hold the trim element in the transverse direction.

14. The arrangement of a trim element as claimed in claim 9, wherein the detachable trim element is also connected to the apron by captive tongues.

15. The arrangement of a trim element as claimed in claim 9, wherein the trim element is a decorative element that at least partially conceals access to a tow ring.

16. A motor vehicle comprising an arrangement of a trim element of a bumper apron as claimed in claim 9.
